(19) United States
(12) Patent Application Publication
(10) Pub. No.: US 2010/0141468 A1
(43) Pub. Date: Jun. 10, 2010

(54) Automatic erosion control, water recovery and fire suppression system

(76) Inventors: Eric A. Artner, Lisle, IL (US); Conrad C. Bar, Long Beach, IN (US)

Correspondence Address: Conrad C. Bar, 2101 Lake Shore Dr., Long Beach, IN, 46360, US

(21) Appl. No.: 12/315,606

(22) Filed: Dec. 4, 2008

(51) Int. Cl. G05B 19/00; B65H 43/00; B65H 77/00; F16M 11/00

(52) U.S. Cl. 340/825; 242/563; 242/412; 248/127

(57) ABSTRACT

The present invention relates to the state of the art automatic erosion control, fire suppression and water recovery storage system. Precipitation sensors automatically activate synchronized motor controls, activating the upper reel and lower tension reel constructing a repellent barrier, diverting and collecting water run-off thereby controlling and prohibiting over-saturation of the soil base, a direct cause of mudslides. Run-off is collected and stored in environmentally safe cisterns. Stored water supplies the incorporated fire suppression system for preventing and controlling fires caused by natural or man-made acts. The fire suppression system is controlled by automatic temperature sensors signals to activate the suppression system. When a threat of fire is over a signal is sent to terminate operations. This system is extremely effective in protecting and enabling the eco-systems by controlling over-saturation allowing a stronger root base. When weather conditions remain dry, the system automatically retracts the barrier for storage.

### BACKGROUND OF THE INVENTION

1. Field of the Invention

The present invention relates to Systems and methods for the automatic control of land surface erosion as well as prohibiting over saturation of the soil base, a direct cause of mudslides. The system will recover and storing water from natural rainfall. Included is an external fire suppression system for the purpose of preventing and controlling fires caused by natural or man-made acts. Specifically, this method constructs a repellent barrier diverting and collecting water run-off (where feasible due to land constraints), thereby controlling soil erosion and enabling water conservation.

2. Description of the Related Art

Erosion control is well known in the art. The most popular forms are often known as “bio-erosion control” (plantings) as well as “drainage Systems”. Typically, such methods are agriculturally based systems or “plantings” and excavation ditches with buried pipe to remove water flow from below the surface. Agriculturally base systems or “plantings” are environmentally safe and help control soil movement by establishing a root base. Unfortunately, they are poor in controlling erosion and in dry conditions can fuel the fire. “Drainage systems” may help direct water run-off that has seeped through the surface but can not control or direct water until the soil is saturated. This leads to two known problems. First: agriculturally based systems may hold the soil base in normal conditions, but has no effect on controlling erosion. Also in dry conditions plantings can become natural fuel promoting fire. Secondly, drainage systems can direct water run-off below the surface but do little to prevent over saturation of the soil base, and do nothing to stem erosion. Also, the existing art has no means of diverting, and storing water run-off for conservation.

The present invention provides an automatically dispensed barrier controlling the water saturation before the water reaches the soil base. Thereby controlling erosion, as well as collects, stores and conserves water. Complementing the invention is an automated fire suppression unit, for use in the suppression of external environmental fires. In addition the system allows the promotion and nurturing of existing vegetation when used as a watering system. The present invention will provide pre-emptive protection against soil over saturation, limiting the need for underground drainage systems. The difficulties inherent in the art are therefore overcome in a way that is simple and efficient while providing better and more advantageous results.

### SUMMARY OF THE INVENTION

One aspect of this invention relates to the state of the art automatic erosion control, fire suppression and water recovery system. Precipitation sensors automatically activate motor controls, which reel out and thereby construct an overlapping repellent barrier impeding, diverting and collecting water run-off (where feasible due to land constraints) thereby controlling and prohibiting over saturation of the soil base, a direct cause of mudslides.

Run-off is collected and stored in environmentally safe cisterns, and is a supply source in the incorporated fire suppression system for the purpose of preventing and controlling fires caused by natural or man-made acts. The system is extremely effective in protecting and enabling the agriculturally based systems, by controlling over saturation and allowing a stronger established root base. (As illustrated within the attached drawings). FIG. 1 is a cross section view of the complete unit; FIGS. 5, 6 and 7 is an overhead view of single, double and over lapping units.

### BRIEF DESCRIPTION OF THE DRAWINGS

The invention may take physical form in certain parts and arrangement of parts, a preferred embodiment of which will be described in detail in this specification and illustrated in the accompanying drawings which form part hereof and wherein:

FIG. 1. Overview of the Automated Erosion Control Fire Suppression Water Containment System, showing the features of the invention.

FIG. 2. Cross Section of Upper Drive Barrier Reel. A perspective side view of the upper drive unit and reeling mechanisms.

FIG. 3. Cross Section of Tension Reel. A perspective side view of the Tension Reel unit and cable mechanisms.

FIG. 4. View of Water Collection & Fire Suppression Unit A side view of the Water collection and mechanisms for the A side view of the Water collection and mechanisms for the incorporated Fire Suppression System.

FIG. 5. Single Reel Unit. An overview of a single barrier unit and tension reel system.

FIG. 6. Double Reel Single Drive. An overhead view of a double barrier reel unit with one main drive.

FIG. 7. Barrier Support Stand. Side view of Barrier supports, providing the main barrier material with support from sagging caused by water and to impede lift in wind driven conditions.

FIG. 8. View of Triple Reel Over-Lap Unit. View of over-lapping units, showing coverage and barrier layout, allowing maximum coverage.

FIG. 9. Anchor options. Alternative methods of attaching the container boxes.

### DESCRIPTION OF THE PREFERRED EMBODIMENT

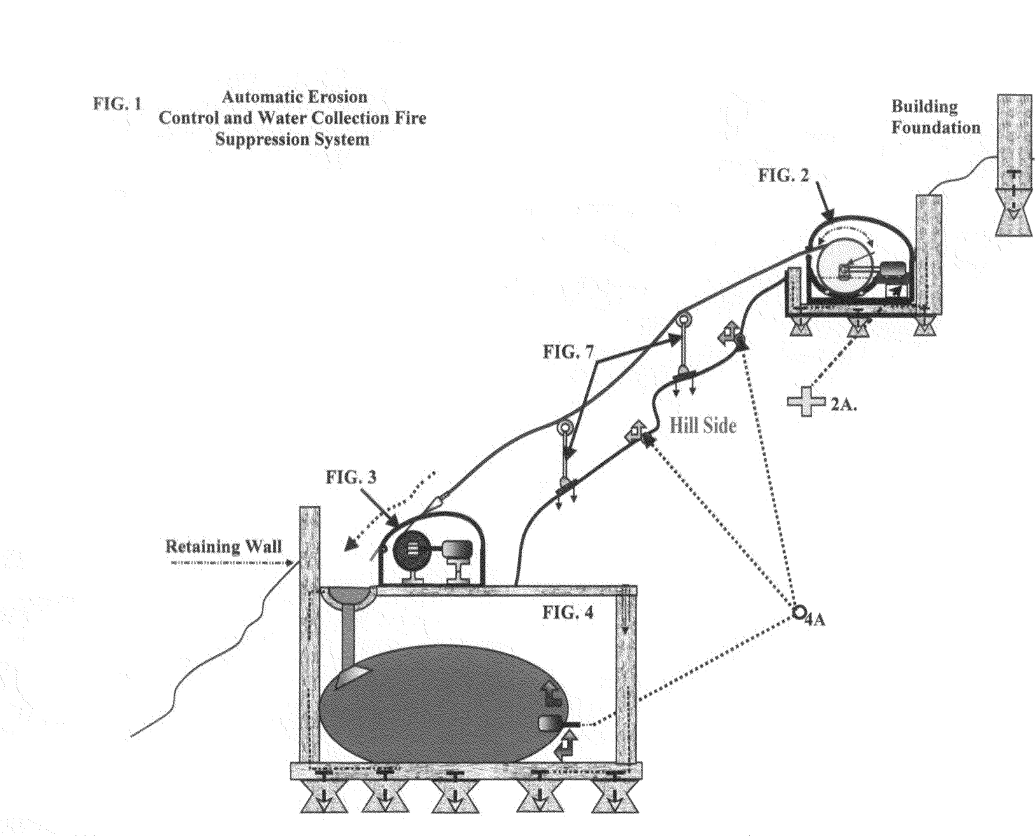

Referring to the drawings wherein the showings are for purposes of illustrating a preferred embodiment of the invention only and not for purposes of limiting same, FIG. 1 shows a cross section of the invention installed on a hill side, complete with water collection cistern and fire suppression system. The preferred embodiment is directed to a hill side but the invention is applicable to other terrain and applications as well. Beginning with the concrete base; No. 2. Preferably a pre-fabricated, reinforced concrete base, using bolt anchors No. 4 imbedded in the form. The base is sealed on all surfaces to prevent concrete dusting and water penetration. The preferred method of anchoring No 1 to No. 2 the poured concrete piers would be the use of threaded rod and locking nuts as required. An alternative method could be, poured concrete pilings with interlocking rebar allowing a poured concrete base to attach to the pilings. Poured concrete walls will be attached with rebar, firmed and reinforces with rebar, then concrete would fill the frame work. After the concrete has cured the framing would be removed leaving a poured concrete foundation. Each part locks together forming a unified-body structure, for strength and ease of assembly.

FIG. 1. No. 2a. A precipitation sensor (manufactured by others) is rated as industrial grade and manufactured to our specifications. No. 2a will be integrated into the master control panel No. 5. No. 2a (precipitation sensor) will turn the system on or off as required when precipitation or rain fall is present (on) or (off) when there is no rain fall. Also the unit will allow an activation delay simply a time delay, to retard the barrier from covering the area. This will enable the vegetation to receive rain fall, promoting growth, aiding in the establishment of deeper root based plants.

FIG. 1 No. 4a Fire Suppression delivery system; is manufactured and installed to our specification. The delivery system in connected and integrated into the water recovery and storage unit and control panel. Activated by heat sensors installed through-out the protected site and will monitor heat registry for the potential of a fire hazard. When activated the system will dispense water drawn from the storage system and disperse the water over the area with heavy duty spray nozzles. Fire prevention is attained through the watering of the vegetation preventing the material to combust.

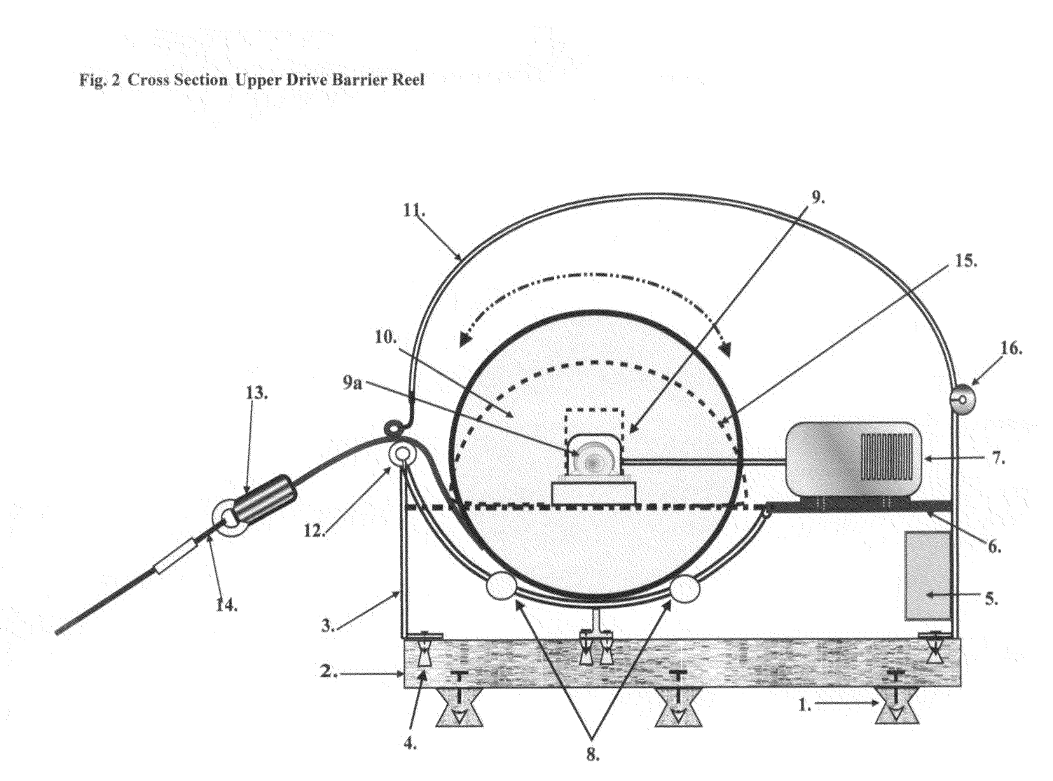

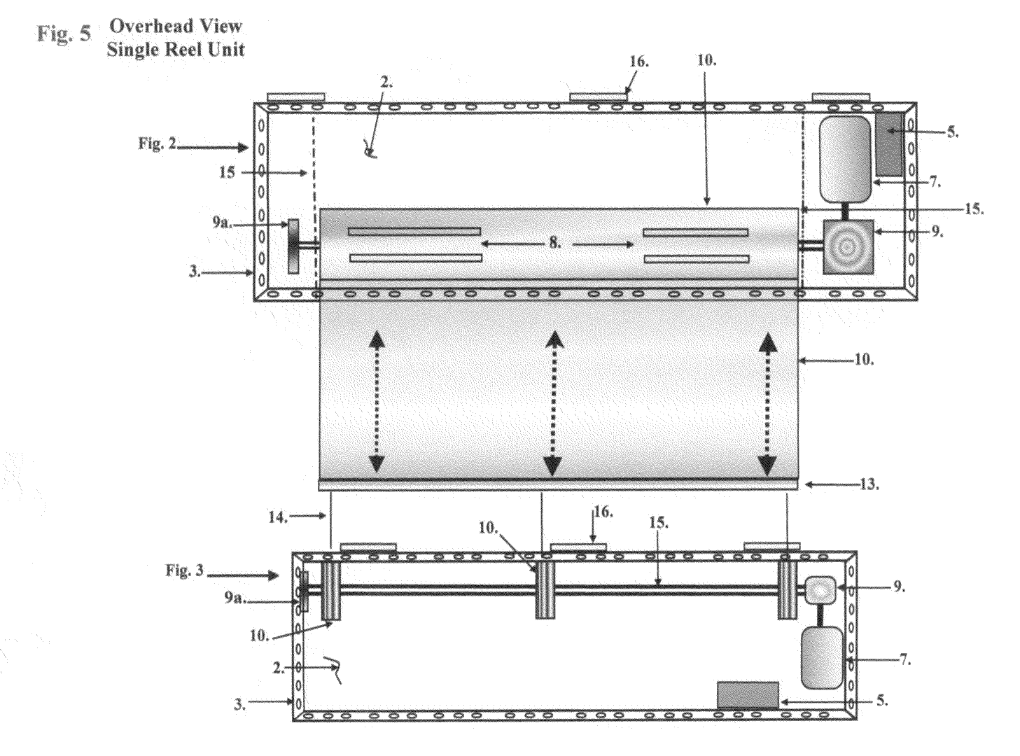

FIG. 2 (Cross Section view of unit) & FIG. 5 (overview of unit) shows the Main Drive that dispenses the Barrier material which is comprised of:

No. 1. Poured concrete pilings interlocked and bolted to No. 2 Alternative method could be, poured concrete pilings with interlocking rebar allowing a poured concrete base to attach to pilings.

No. 2. Preferably a prefabricated, reinforced concrete base, using bolt anchors No. 4 imbedded in the form. The base is sealed on all surfaces to prevent concrete dusting and water penetration. The preferred method of anchoring No 1 to No. 2 the poured concrete piers would be the use of threaded rod and locking nuts as required. An alternative method could be, poured concrete pilings with interlocking rebar allowing a poured concrete base to attach to the pilings Poured concrete walls will be attached with rebar, framed and reinforces with rebar, then concrete would fill the frame work. After the concrete has cured the framing would be removed leaving a poured concrete foundation. Each part locks together forming a unified body structure, for strength and ease of assembly. The invention has the flexibility to allow the structure to set on an above ground foundation base or a below ground level (concrete) wall foundation. This allows a means to camouflage or hide the main barrier reel unit from view, without hampering its operation. (See FIG. 1.)

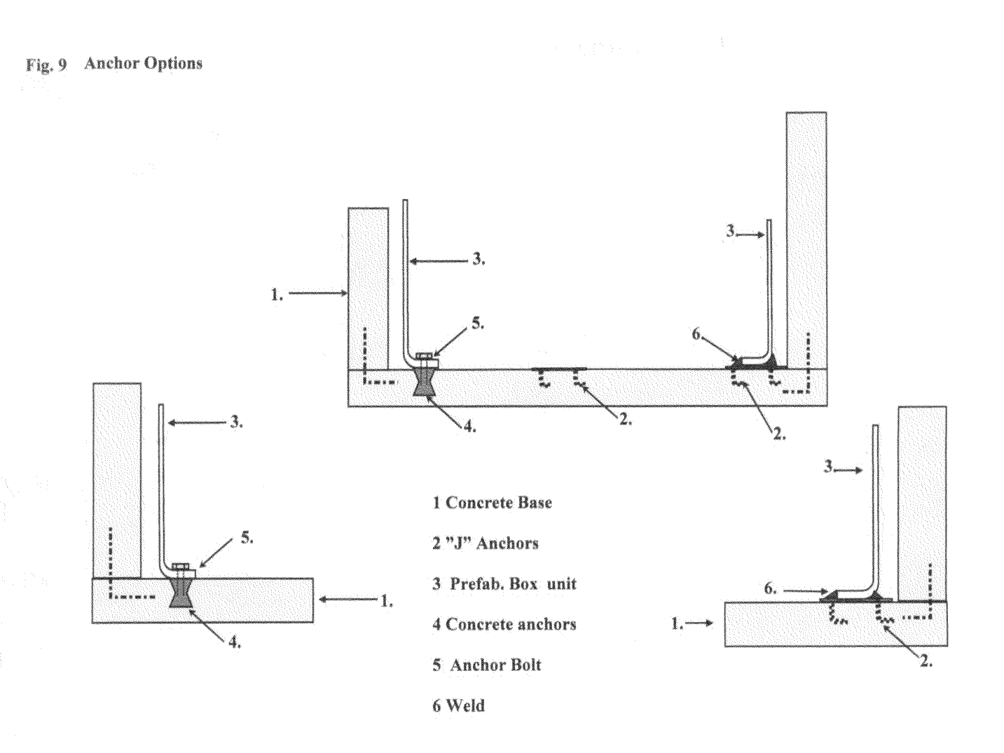

No. 3. The parts should be manufactured from burnished sheet aluminum or sheet steel, preferably a modular fabrication. The best method for attaching No. 3 to No. 1, would be The use of a waterproof silicon sealant; which forms a water tight barrier against moisture and preferably, would be fastened with anchor bolts No. 4 and 5 view FIG. 9.

An alternative method to attach No. 3 and No. 2 would be to embed an anchor plate with “J” hook No. 2 view FIG. 9 attachments or similar anchoring method into the prefabricated or poured base before the substrate cures, and welding No 3 to No. 2 view FIG. 9 embedded in the concrete foundation No. 2. The material cradle and electric motor mounting bracket

No. 6 preferably a one piece prefabricated unit with phenolic live rollers No. 8 inserts. Each part locks together forming a unified-body structure, for strength and ease of assembly.

No. 11. The cover, should be manufactured of burnished sheet aluminum or steel curved to allow run-off. The cover can be attached to No. 3 using a hinge mechanism.

No. 8. Cradle live rollers, pre-assembled with press phenolic live rollers bearing to allow free forward and reverse motion of barrier material and preferably will be attached with bolts and lock nuts to No. 1, but may be welded.

All fabricated parts should be coated with a low VOC water born enamel or baked powder coat, internal and external application.

No. 5 Control/power panel. This unit should be a total enclosed vented control and electrical box. The control power box will containing all automatic control panels, remote control manual over ride boards, precipitation sensor control panel and electrical power switch systems. This could be mounted with fasteners, or spot welded to No. 1 or the control/power panel could be a stand alone unit.

No. 6 The electric motor mounting bracket and material cradle, to allow the securing of No. 7 the electric drive motor to No. 1. To be attached with bolts and lock nuts or welded. This part No. 6 is to be attached (bolted or welded to the base No. 2 and No. 3 the vertical walls of the container, thus adding strength to the complete unit and stabilizing the material cradle.

No. 7. Is preferably a totally enclosed, explosion proof reversing Drive motor, an alternative motor could but a general purpose electric motor. The motor No. 7 should preferably be mounted to No. 6 with locknuts and bolts, but the motor may be spot welded to the surface of No. 6.

No. 16 The hinge unit allows No. 3 and No. 11 to be combined and open freely. This part should be attached preferably with round head bolts, lock washers and lock nuts. An alternative method to attach No. 16 could be a full or spot weld. Covers should be operated manually but could be operated as an automated unit.

No. 9 Shows an industrial gear driven speed reducer with reversing capabilities with manual over ride. The reducer will allow RPM rotation and speed control between No. 7 the drive motor and No. 10 the barrier material reel.

No. 10 Manufacture from a commercial grade barrier material, preferably a waterproof fabric such as cotton, nylon, nylon/polyester blend, with a reinforced with polyester or equivalent substrate for strength. The banner material should meet all flame retardant, rot resistant, tear resistant and waterproof specifications for a barrier material.

No. 9a Incorporated is a drive shaft mounting coupling and pillow block bearing assemble which allows the connecting of No. 9 the reducer to the shafted barrier reel No. 10.

No. 11. The burnished sheet aluminum or steel cover, curved to allow water run-off. All surfaces should be coated with low VOC water born enamel or baked powder coat, internal and external application. The cover No. 11 forms a barrier to prevent water, debris from entering the main unit.

No. 12 A phenolic material guide; specifically for the ease of motion and reduced friction and will minimize ware, as the barrier is engaged and retracted.

No. 13 A barrier pull bar preferably manufactured of aluminum or phenolic material, while possessing a light weight yet strong and ridged structure. The barrier material No. 10 attaches to No. 13 the pull bar No. 14 the tension cable attaches to No. 13. This will allow consistent tension and even material out put and rigidity.

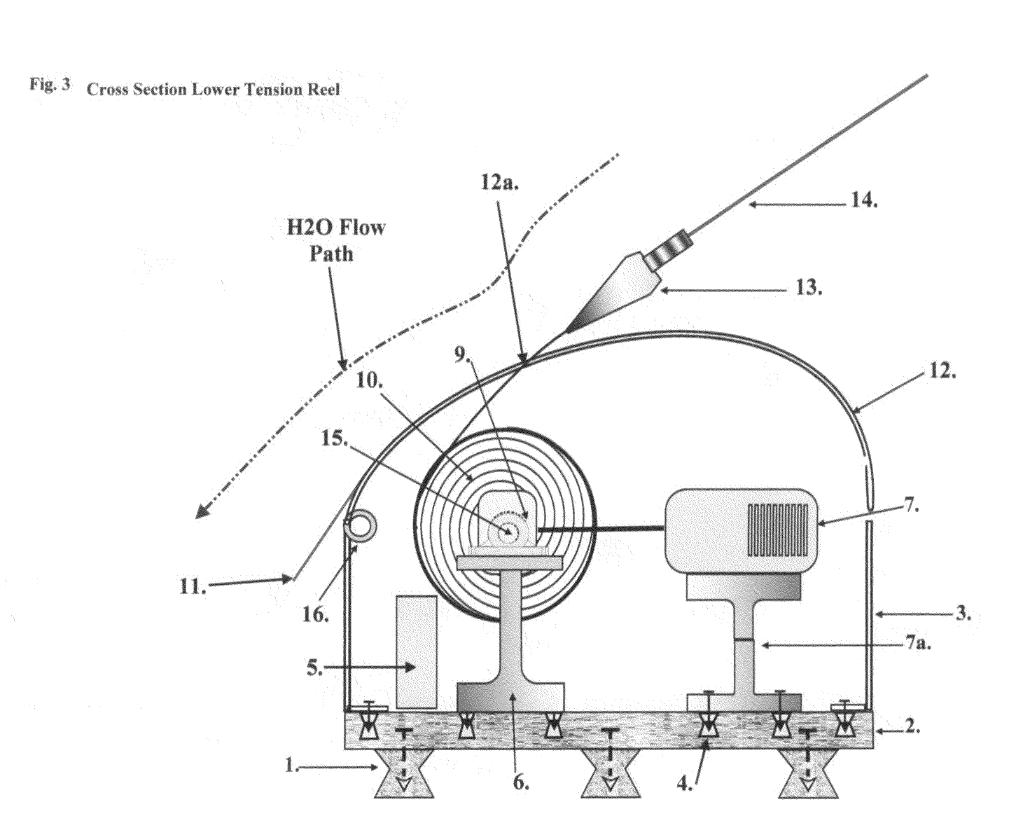

No. 14. Preferably a ¼″ Tension cable. Material should be of rust resistant material, such as Stainless Steel twist cable, nylon reinforced cable or equivalent. For attachment to No. 10, No. 13 view FIG. 2. The cable reel; No. 10 view FIG. 3; the tension cable creates a pulling action for the dispensing of the barrier as well as maintaining adequate tension on the barrier material.

No. 15 The Reel material Guide is manufactured preferably of burnished sheet aluminum or sheet steel making up a modular fabrication. The reel guide may be attached to No. 3 the vertical walls and No. 2 the concrete base, with bolts and lock washers or can be welded. This allows control of the deployment and retraction of No. 10. This guide will maintain a tight material configuration within the cradle.

The Lower Tension Cable Reel which retracts cable No. 14 and maintains tension on the barrier. Providing, flow control and will direct the flow of runoff for collection or dispersal.

FIG. 3 and FIG. 5 (overview of unit) shows the Tension Cable Reel and is comprised of:

No. 1. Poured concrete pilings interlocked and bolted to No. 2. Alternative method could be, poured concrete pilings with interlocking rebar allowing a poured concrete base to attach to pilings.

No. 2. Preferably a prefabricated, reinforced concrete base, using bolt anchors No. 4 imbedded in the form. The base is sealed on all surfaces to prevent concrete dusting and water penetration. The preferred method of anchoring No 1 to No. 2 the poured concrete piers would be the use of threaded rod and locking nuts as required. An alternative method could be, poured concrete pilings with interlocking rebar allowing a poured concrete base to attach to the pilings. Poured concrete walls will be attached with rebar, framed and reinforces with rebar, then concrete would fill the frame work. After the concrete has cured the framing would be removed leaving a poured concrete foundation. Each part locks together forming a unified-body structure, for strength and ease of assembly.

No. 3. The parts should be manufactured from burnished sheet aluminum or sheet steel. Preferably manufactured as a modular fabrication. The best method for attaching No. 3 to No. 1 would be to use a waterproof silicon sealant; which forms a water tight barrier gasket against moisture. Anchoring, method would preferably be fastened with anchor bolts No. 4 and 5 view FIG. 9.

An alternative method to attach No. 3 and No. 2 would be to embed an anchor plate with “J” hook No. 2 view FIG. 9 attachments or similar anchoring method into the prefabricated our poured base before the substrate cures, and welding No. 3 to No. 2 view FIG. 9 embedded in the concrete foundation No. 2.

No. 5 A control/power panel, preferably a total enclosed vented control and electrical box. The control/power panel will containing, all automatic control panels, remote control manual over ride boards, precipitation sensor control panel and electrical power switch systems. This unit links the FIG. 2 unit together for total automatic synchronization. This could be mounted with fasteners, or spot welded to No. 1 it is possible the control/power panel could be a stand alone unit.

No. 6 The Shaft support mounts supply a stable base for the cable shaft and is clamped to The shaft with pillow block bearings that are bolted or welded to the support shaft mount No. 6. The support shaft mount is anchored to the base No. 2 with anchors and anchor bolts or can be welded to plates inserted in the concrete base.

No. 7 Is preferably a totally enclosed, explosion proof reversing Drive motor, an alternative motor could but a general purpose electric motor. The motor No. 7 should preferably be mounted to No. 7a with locknuts and bolts, but the motor may be spot welded to the surface of No. 7a.

No. 7a. The drive motor mounting stand No. 4 is attached to No. 3 with anchor bolts or may be welded to an embedded plate. The cable reel shaft No. 5 shall be attached to No. 3 with anchor bolts or may be welded to an embedded plate.

No. 9. A gear driven reversing speed reducer with manual over ride; allowing RPM rotational and speed control between No. 7 and No. 15. No. 10.

No. 9a Shaft pillow block bearings aligned and fitted to the cable reel shaft No. 15, the bearing allow reduced friction rotation of the shaft.

No. 10. Take up cable accumulator Shaft. Supports cable reels for the dispensing and retraction of tension cable.

No. 11 Water guide. This guide controls water run-off away from No. 1 and No. 2 this will prevent water from entering the seam between the cover No. 2 and No. 1 the vertical wall of the container box. The guide should be manufactured of a ridged waterproof material and cam be attached to the cover No. 12 with gasket seal and screws.

No. 12. The burnished sheet aluminum or steel cover, curved to allow water run-off. All surfaces should be coated with low VOC water born enamel or baked powder coat, internal and external application. The cover No. 12 forms a barrier to prevent water, debris from entering the main unit And provides cable ports or guides No. 12a, allowing the cable No. 14 to move unencumbered from the cable accumulators No. 10 and attaching to the pull bar No. 13. The matting of the cover No. 12 and the pull bar No. 13 will cover the cable ports and form a seal against water and debris.

No. 13 Pull bar manufactured of aluminum or phenolic material. No. 10 attaches to No. 13. No. 14 attaches to No. 13, Will allow consistent tension and even material out put and barrier rigidity.

No. 14. ¼′ Tension cable. Material should be of rust resistant material, such as Stainless Steel twist cable, nylon reinforced cable etc. Attaches to No. 10, No. 13 view FIG. 2.

No. 15 Reel shaft attaches to the gear reducer No. 9 and the drive motor No. 7. Aligned on the reel shaft are pillow bearing cable reel No. 8a, and is supported buy No. 6 the shaft support mounts.

No. 16. Hinge unit allows No. 3 and No. 12 to be combined and open freely. This part should be attached preferably with round head bolts, lock washers and lock nuts. An alternative method to attach No. 16 could be a full or spot weld. Covers should be operated manually but could be operated as an automated unit.

### Water Collection and Fire Suppression System

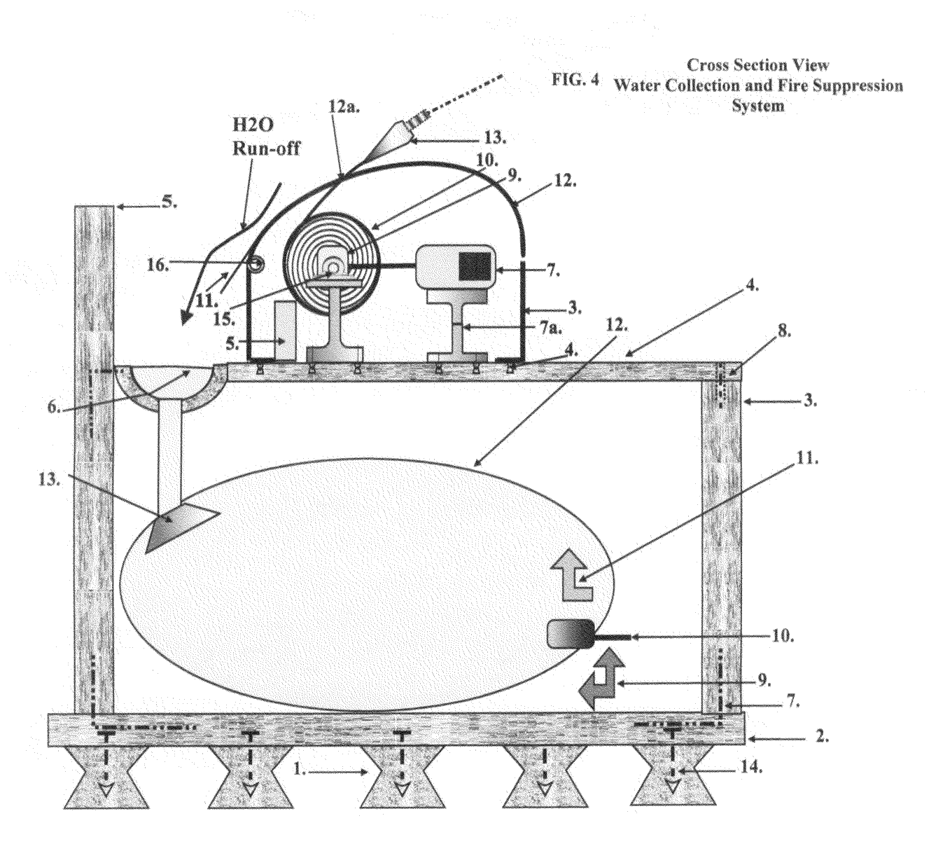

Water Collection and Fire Suppression System, FIG. 4 allows the recovery and storage of run-off water. Incorporated into the system is the fire suppression system, allowing the system to dispense the stored water in the prevention of potential fire hazard.

FIG. 4. Water Collection and Fire Suppression System. Shows a cross section of the water collection system and is comprised of:

No. 1. Poured concrete piling interlocked and bolted to No. 2. Alternative method could be, poured concrete pilings with interlocking rebar allowing a poured concrete base to attach to pilings.

No. 2. Preferably a prefabricated, reinforced concrete base, using bolt anchors No. 4 imbedded in the form. The base is sealed on all surfaces to prevent concrete dusting and water penetration. The preferred method of anchoring No 1 to No. 2 the poured concrete piers would be the use of threaded rod and locking nuts as required. An alternative method could be, poured concrete pilings with interlocking rebar allowing a poured concrete base to attach to the pilings. Poured concrete walls will be attached with rebar, framed and reinforces with rebar, then concrete would fill the frame work. After the concrete has cured the framing would be removed leaving a poured concrete foundation.

No. 3. Retaining wall and flow control barrier. Provides stable footing and is, attached to No. 2 the base No. 8. The containment cover and No. 6 the run off trough.

No. 4. the cistern cover, would be constructed of preferably prefabricated reinforced concrete and a pre-formed inspection access port, to allow entrée for inspection of tank and equipment.

No. 5 A prefabricated or poured concrete retaining wall and anchoring point for No. 2 the base and No. 6 the run-off trough.

No. 6 Run-off trough controls runoff and directs water run-off to the Pillow Tank No. 12. the run-off trough is attached to No. 5 and No. 4.

No. 7. Anchor Rods used to attach the base No. 2 to the walls No. 3 and No. 5.

No. 8. Cover locking rods allowing the cover No. 4 to the walls No. 3 and the run-off trough No. 6. The locking rods No. 8 should be manufactured if threaded rod allowing ease of tightening to allow removal and repair of cover.

No. 9. The leek detection system monitors any leeks or purging into the concrete containment barrier. Connected to Panel No. 5 view FIG. 3.

No. 10. Pump motor control unit. The pump motor and controls meters H2O to the fire suppression system. The fire suppression system is remote controlled to allow the hampering, preventing and controlling fires caused by natal or man made acts.

No. 11. Volume meter. Checks the level of fluid in the pillow tank No. 12. Monitored at No. 5 control panel FIG. 3.

No. 12. Pillow tank, is a water containment unit for the storage of recovered water run-off. The collapsible, flexible storage bladder tank; is designed for land based operations. The bladder is fabricated with puncture proof material. Environmentally safe tanks are sized by application. (Installed where feasible). Instillation is dependent upon site limitations referencing, topography, site location to adjoining property and geology. The cistern capacity is based on the size limitation with reference to the lot or site size and the degree (angle) of slope at the base of site.

No. 13 The automatic shut off valve. The automatic shut off valve will automatically close when No. 12 the pillow tank is full. Run-off will be diverted to drainage pots as an alternative method of controlling run-off.

### Cross Section of Single Drive Reel Unit FIG. 5

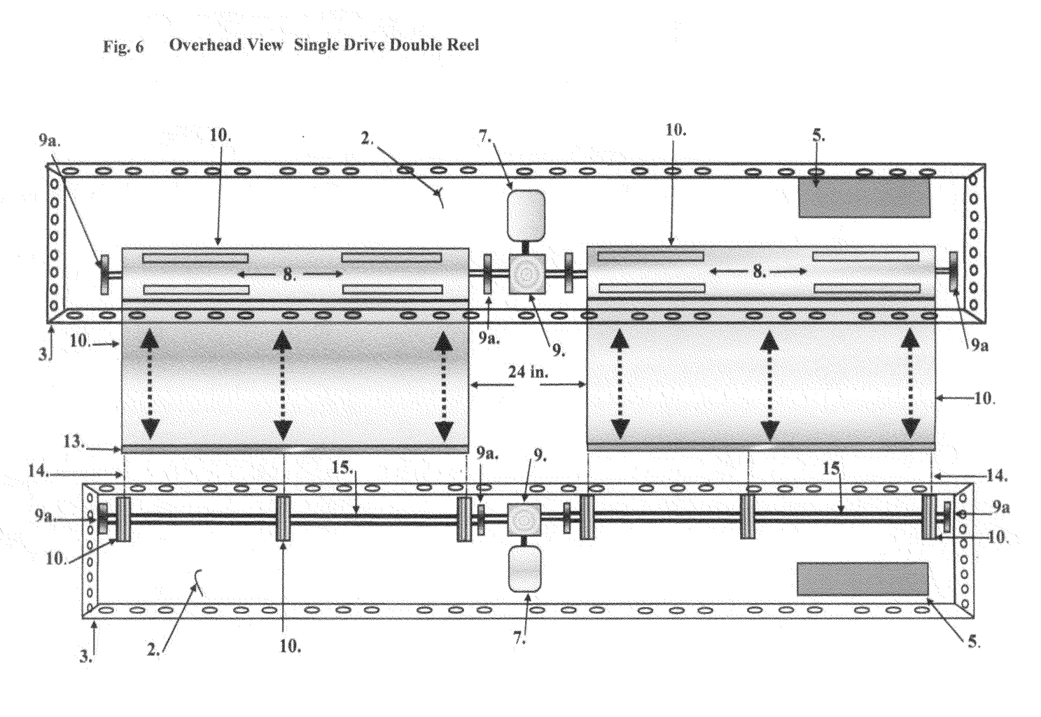

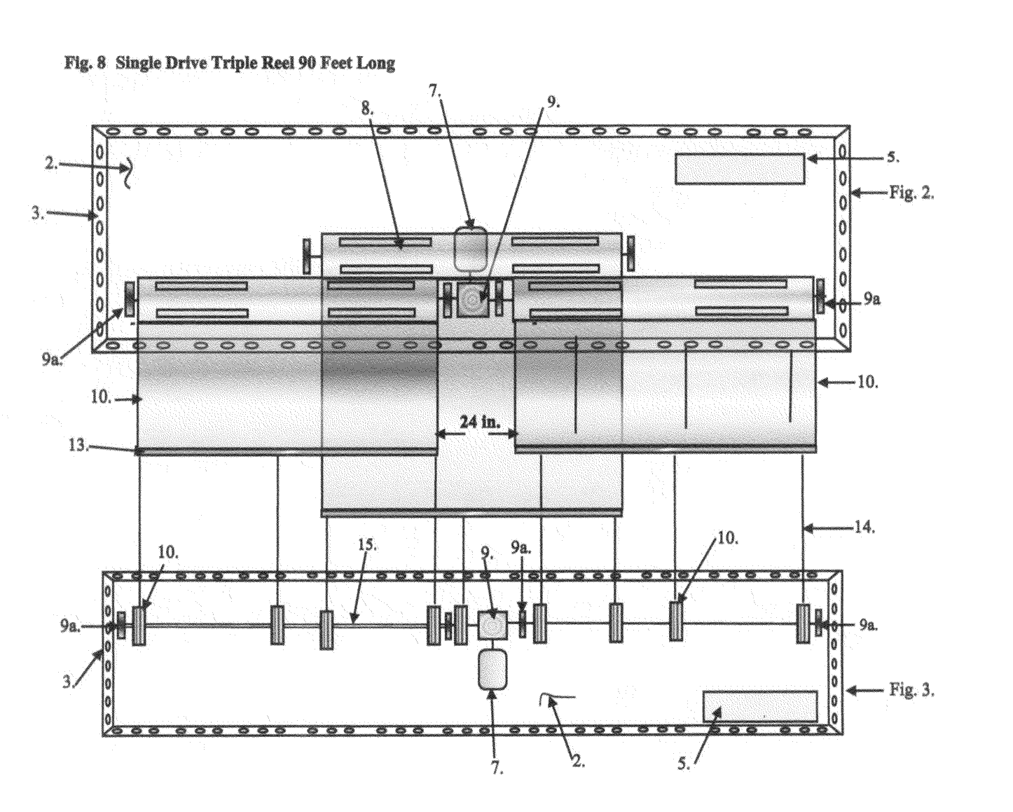

Note: FIG. 5. Identically constructed as FIG. 2, FIG. 3 and FIG. 6. This is a Single Drive motor, and single gear box, driving one reel of barrier material. This also applies to the Lower Cable Reel FIG. 3 and FIG. 6. One drive unit per two take-up Reels.
Overview of Double Reel Single Drive & Overlapping three reel Unit FIG. 6. FIG. 8
Note: FIG. 6. and FIG. 8 contains all the same parts and material aforementioned in FIG. 2 and FIG. 3. This view affords an overhead view if the mating of the two units. FIG. 8 depicts the overlapping of barriers controlling and regulating water contact with to the surface soil.

### Self Adjusting Barrier Supports Stands

The barrier support stands have been designed for the specific function of providing a support base for the waterproof barrier material. Each stand is installed independent of the other, which allows a flexible support pattern. The support stands are of a modular construction and are adjustable for height and angle, which will compensate for the terrain the units will be installed upon. A coated twist cable is installed over the base and barrier material and tightened (much in the manner of a take-up line). With the coated cable in place, the barrier will be secure and any sailing or billowing from winds will be prevented.

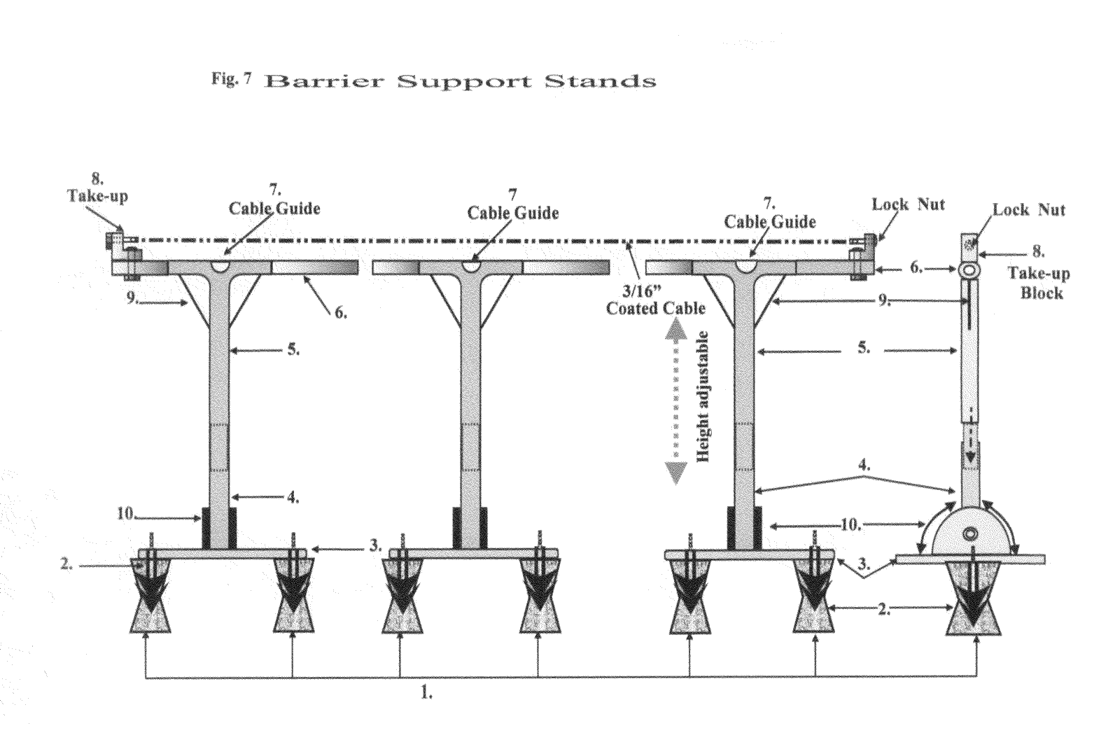

### FIG. 7 Self Adjusting Barrier Supports Stands

No. 1. Poured concrete footers with threaded anchor rods No. 2. These rods are secured into the concrete footers and the threaded rod will fit through the base plate No. 3 and bolted tightened. This will allow the anchoring of the support stand, with a minimal of movement under stress.

No. 2 Base plate, a metal plate used to attach the unit No. 7 to the poured concrete footers.

No. 3 Base sleeve is attached to the adjusting slotted platform. The recommended attachment method should be a long blot and lock nut fastener system. This will allow the unit to be set at the proper angle and then tightened in place. This method of attachment will lend a flexible and easy adjustable mode of attachment.

No. 4 Aluminum square or round tubing within Aluminum square or round tubing slotted for adjustability, vertically a sleeve fit. The recommended fastener would be bolt and nut, but the unit could be welded to No. 3, in fabrication.

No. 5 Upper-T support unit is attached to No. 3 base sleeve and forms the upright support. The units can be fastened with bolts and nuts, machine steel screws or welded.

No. 6 Support wings. The wins are manufactured from round aluminum tubing. The cable guide slots are established in fabrication. The wings can be attached by welding to No. 4 or an alternative would be to (socket fit with screw fasteners or threaded male and female coupling) to No 4 in the fabrication process.

No. 7 Cable Guides. The stainless steel twist cables guide No. 6 are manufactured groves, that guide the barrier as the barrier is pulled over the support stands FIG. 7 the barrier is given extra rigidity and the adjustable height will allow the barrier move over the area and plant life will not interfere with the forming of the barriers shielding action.

No. 8 Anchor block and lock nut. Attached to No. 6 with preferred machine nuts and bolts but as an alternative method can be welded. This unit is an anchoring point for the coated twist steel cable that will cross over the barrier. The cable is attached to the other end of the unit and is fitted to the take-up block.

No. 8 Take-up blocks Attached to No. 6 with preferred machine nuts and bolts but as an alternative method can be welded. The part receives the coated cable and acts as the mechanism; applying tensioning and tightening the cable over the barrier.

No. 9. Support braces can be added if and when added support is required. The braces can be attached with screws, bolts and nuts or welded, to No. 5 the upper “T” support and can be installed to the base sleeve unit No. 4 in the same manner as No. 5. It is advisable to attach the braces No 9 only after the proper angle alignment is attained and the unit are locked in place.

No. 10. Adjusting bracket is an incrementally engineered bracket to be attached to the base plate No. 3; the attaching method can be welded, fastened with screws or bolted to No. 3 the base plate. This part will then be attached to No. 4 the lower support with a preferred long bolt and nut. Attachment in this manner allows the support to be aligned in increments and locked in place, as well as enabling ease of adjustment.

“While the present invention has been described in terms of specific embodiments, it is to be understood the invention is not limited to these disclosed embodiments. The invention may be embodied in many different forms and should not be construed as limited to the embodiments set forth herein; rather, these embodiments are provided by way of illustration only and so that this disclosure will be thorough. Complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.”

What is claimed: An Automatic Erosion Control Water Recovery and Fire Suppression System being comprised of:

1. An Upper Drive Barrier Reel Unit comprising
A storage and drive unit that dispense and houses the waterproof barrier and drive motor and main control panel.
Reinforce concrete footers are established on a pre graded site. Threaded rod or rebar will be used to attach the prefabricated or poured reinforced concrete base slab. Attached the base is an upper drive barrier reel unit that stores and dispenses the waterproof barrier.
The main reel is comprised of a fabricated metal container that will house the drive and barrier material reel components. Manufactured from metal sheet the wall units will be secured to the base by means of bolting to pre formed anchors in the base or welding the walls to embedded plates in the concrete base.
The material cradle holds the waterproof barrier roll comprised of: a manufactured waterproof and frame retardant material that will be sized to the application accompanying and attached to the cradle outer wall is a phenolic guard to reduce friction and ware to the barrier material.
With incorporated live rollers the barrier reel is placed in the cradle and will set on the incorporated live rollers units and reel shaft pillow bearings; this combination allows free forward and reverse movement of the barrier roll aiding in the reduction to stress on the reel shaft.
A drive motor and speed reduction gear box provide power and rotational speed control to the reel shaft and material reel.
A control and power panel enclosure will contain all power, drive and sensor controls governing all power, sensor and mechanism management. This unit will be synchronized with a secondary control panel located in the tension unit.
A unit cover attached by hinges to the anchored containment walls to protect the internal equipment from contaminants and allow equipment inspection and repair. Incorporated into the cover is a guide plate for the management of the barrier material.
A phenolic bar is incorporated into the barrier material to supply a ridged attaching base for tension cable.

2. A Tension cable reel upon activation supplying tension on the barrier material Comprised of:
Reinforce concrete footers are established on a pre graded site. Threaded rod or rebar will be used to attach the prefabricated or poured reinforced concrete base slab. Attached the base is an upper drive barrier reel unit that stores and dispenses tension cables.
The tension cable reel is comprised of a fabricated metal container that will house the drive and cable reels components. Manufactured from metal sheet the wall units will be secured to the base by means of bolting to preformed anchors in the base or welding the walls to embedded plates in the concrete base.
A drive motor and speed reduction gear box provide power and tension speed control to the shaft and cable reel.
Cable shaft with cable reels for the accumulation and containment of the tension cable, pillow bearing for ease of motion as id coupled with the drive unit.
A control and power panel enclosure will contain all power, drive and sensor controls governing all power, sensor and mechanism management. This unit will be synchronized with a main control panel located in the barrier unit
A unit cover attached by hinges to the anchored containment walls to protect the internal equipment from contaminants and allow equipment inspection and repair. Incorporated into the cover is a cable port for the management of the cable and to provide a tight connection point between the barrier and tension cover. Affixed to the cover is a-flow shield enabling management of water run-off.

3. Water Collection and Fire Suppression System comprised of:
Water storage and dispensing system comprising:
Reinforce concrete footers are established on a pre graded site. Threaded rod or rebar will be used to attach the prefabricated or poured reinforced concrete base slab. To be anchored to a reinforced concrete retaining wall. Connected concrete vertical walls will form a container.
Pillow tank, is a water containment and level monitoring unit for the storage of recovered water run-off.
Reinforce concrete water collection and diverting trough. Installed for the control and collection of run-off water.
A leek detection sensor, to monitor leeks of the storage tank.
An automatic fire suppression pump automatic sensor activation of high pressure water flow to the integrated fire suppression piped system.
Fire suppression system (to be manufactured by others) for the dispersal of collected water in the pillow tank Activation will be through heart sensors and the control panel.

4. Barrier support stands for the stabilization of the water proof barrier material is comprised of:
Reinforce concrete footers are established on a pre graded site. Threaded rod or rebar will be used to attach the prefabricated or poured reinforced concrete base slab.
Metal base plate attached to the footer by threaded rod and lock nuts or metal rods welded to the base plate.
Adjusting bracket, allowing incremented liner angle adjustments. Connected to the lower vertical support, with bolts and nuts for ease of adjusting.
Lower vertical support for a base of the upper sleeve.
Adjustable upper “T” support allowing vertical height adjustment to establish a support base for the barrier material.
Horizontal base sleeves providing a larger support platform to support the barrier material and anchor points for the integrated cable take-up blocks.
Cable take-up blocks allowing a coated cable that spans over the barrier canopy, protection from wind up drafts and sailing.
